(19) United States
(12) Patent Application Publication
(10) Pub. No.: US 2015/0268342 A1
(43) Pub. Date: Sep. 24, 2015

(54) TIME OF FLIGHT PROXIMITY SENSOR

(71) Applicant: Masco Canada Limited, St. Thomas (CA)

(72) Inventors: Jeffrey Joseph Iott, Taylor, MI (US); Stephen Stec, Dearborn, MI (US); Kent Rittenhouse, Holland, OH (US); Paul McLennan, London (CA); Frank Anthony Stauder, London (CA)

(21) Appl. No.: 14/661,567

(22) Filed: Mar. 18, 2015

Related U.S. Application Data
(60) Provisional application No. 61/955,276, filed on Mar. 19, 2014.

(51) Int. Cl. G01S 17/06; F17D 3/01

(52) U.S. Cl. CPC G01S 17/06; F17D 3/01

(57) ABSTRACT

An automated dispensing fixture includes a controller controllably coupled to at least one valve. The valve is operable to control fluid flow through a dispensing fixture. The automated dispensing fixture also includes at least one time of flight sensor communicatively coupled to the controller, such that the controller is operable to detect a position of an object relative to the dispensing fixture.

### CROSS-REFERENCE TO RELATED APPLICATION

This application claims priority to U.S. Provisional Application No. 61/955276 filed on Mar. 19, 2014.

### TECHNICAL FIELD

The present disclosure relates generally to automatic dispensing fixtures, and more particularly to a proximity sensor arrangement for the same.

### BACKGROUND

Existing automated dispensing fixtures, such as publicly accessible plumbing fixtures, commonly utilize position sensors to determine a user's proximity to the fixture, and perform an action based on that proximity. For example, an automated sink in a public restroom will automatically turn on as a user's hands approach the faucet, and turn off once the user has removed their hands from the faucet vicinity. Similarly, an automatic flush toilet will automatically flush when a user moves outside of a predetermined threshold distance from the sensor in the toilet fixture. Alternatively, some automated dispensing fixtures detect a presence of an object and cause a controller to respond accordingly.

In order to detect the proximity of the user to the fixture, multiple types of sensor assemblies are available that can be built into the fixture. A first example sensor type is a reflected light/sound device. Sensing the level of reflected light includes inherent problems resulting from the variances in emissivity of objects, the size of the target object, and the orientation of the target or the sensors. The variances introduce large margins of error that are incorporated into the detection algorithm and can result in plumbing fixtures either being too sensitive and turning on improperly or not being sensitive enough and failing to activate.

Alternatively, some current automatic fixtures utilize a triangulation sensor (alternately referred to as a position sensing device, or a PSD). Triangulation sensors are significantly larger than reflected light/sound sensors, include significantly more expensive components, and require significantly more power to operate. Thus, while more accurate than reflected light/sound sensors, triangulation sensors have an increased upfront cost as well as an increased operational cost relative to reflected light/sound sensors.

### SUMMARY OF THE INVENTION

Disclosed is an automated dispensing fixture including a controller controllably coupled to at least one valve operable to control fluid flow through a dispensing fixture, and at least one time of flight sensor communicatively coupled to the controller, such that the controller is operable to detect a position of an object relative to the dispensing fixture.

Also disclosed is a method of operating an automated dispensing fixture including detecting a position of an object relative to the dispensing fixture utilizing at least one time of flight sensor by emitting a pulse of light from an emitter in the at least one time of flight sensor, detecting a reflection of the emitted light at a receiver in the at least one time of flight sensor; detecting a travel time of the emitted light based on the detected reflected light, determining a first value representative of at least one of a distance between the object and the dispensing fixture and the presence of the object in a target area based on the time delay of the reflected light, and transmitting the value to a controller operable to control the automatic dispensing fixture.

Also disclosed is an automated dispensing fixture including a controller controllably coupled to at least one actuator operable to control flow through a dispensing fixture; at least one time of flight sensor communicatively coupled to the controller, such that said controller is operable to detect a position of an object relative to the dispensing fixture; and wherein the actuator is one of a motor and a solenoid.

These and other features of the present invention can be best understood from the following specification and drawings, the following of which is a brief description.

### BRIEF DESCRIPTION OF THE DRAWINGS

FIG. 1 schematically illustrates an example automated shower fixture.

FIG. 2 schematically illustrates a time of flight sensor.

### DETAILED DESCRIPTION OF AN EMBODIMENT

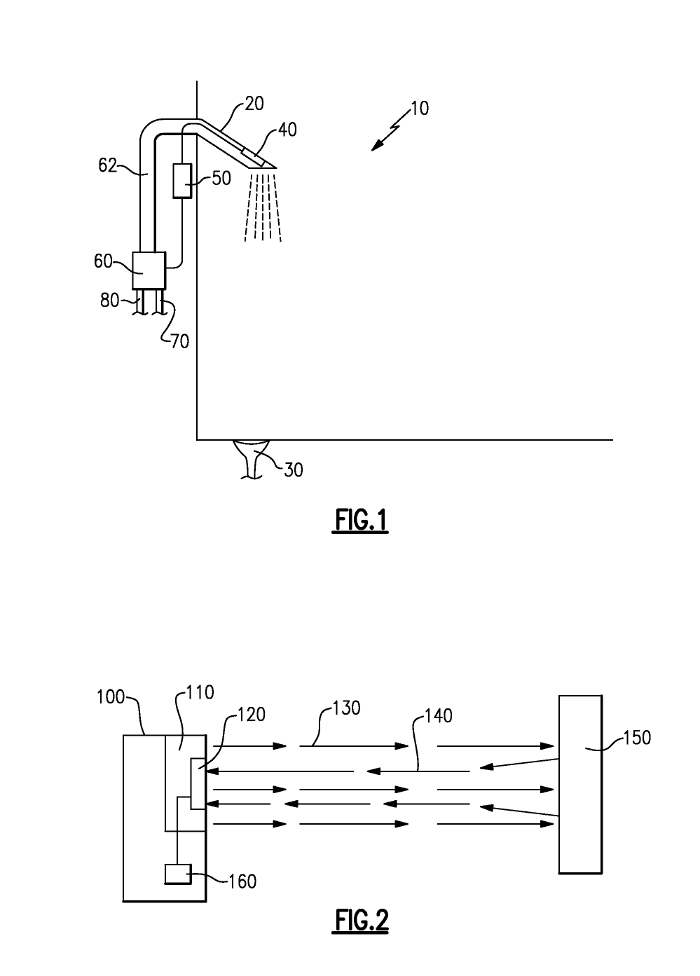

FIG. 1 schematically illustrates an automatic shower assembly 10 including a shower fixture 20 with a time of flight sensor 40 built into the shower fixture 20. The time of flight sensor 40 uses time of flight sensing to detect a position of a user relative to the shower fixture 20. The time of flight sensor 40 is connected to a valve controller 50 that interprets the sensed position information and operates a valve 60 when the user is within a set threshold distance. The valve 60 controls the flow of a hot water supply 70 and a cold water supply 80 to the shower fixtures 20 through a main pipe 62. Water exits the shower assembly 10 through a waste water drain 30. In alternative examples, the time of flight sensor 40 can be utilized in conjunction with an automatic flush toilet, an automatic sink, or any other automatic plumbing fixture in place of the illustrated shower assembly 10. In alternative examples, the valve structure can be replaced with a motor, a solenoid, or a similar flow driving structure. In such an example the flow driving structure drives flow through the fixture as well as controlling the rate of flow.

With continued reference to FIG. 1, FIG. 2 illustrates a time of flight sensor 100 detecting a distance of an object 150 from the time of flight sensor 100. The time of flight sensor 100 is one example of a time of flight sensor that can be used in the shower assembly 10, or in any other similar automated plumbing or automated dispensing arrangement. The time of flight sensor 100 includes an infrared emitting diode 110 that is pulsed at a high frequency and floods a target zone with IR light energy 130. The IR light energy 130 contacts the object 150 in the target zone, and a reflected light energy 140 is created. An infrared detector 120 embedded in the time of flight sensor 100 detects the reflected light energy 140. The reflected light energy 140 includes a time delay resulting from the time the light spent traveling from the emitter 110 to the object 150 and back to the receiver 120. In alternative embodiments, the infrared emitting diode 110 can be replaced with a vertical-cavity surface-emitting laser (VCSEL), and function in approximately the same manner.

A signal processing circuit 160 within the time of flight sensor 100 measures the time delay between the emitted light energy 130 and the received reflected light energy 140. The magnitude of the time delay is dependent upon the distance that the light traveled, and the distance can be calculated according to known light transmission principles. Based on this dependency, the signal processing circuit 160 determines a distance value representative of the distance between the object 150 and the sensor 100.

In the example of FIG. 1, a distance value determined by the signal processing circuit 160 is provided to valve control logic contained in the valve controller 50. The valve controller 50 then utilizes the distance value as a factor in the decision to turn the valve 60 on, or allow the valve 60 to remain on to supply water to the user, or to turn the valve 60 off. In alternate arrangements, the distance value can be replaced with a binary “presence of an object” determination, or any other similar proximity determination. Presence of an object can be determined whenever an object is closer than a preset threshold distance, or using any other known methodology.

Time of flight infrared (IR) light based sensors, such as the time of flight sensor 40 in FIG. 1, are immune to emissivity variations. As the distance measurement is determined by the time the light spends traveling to the object and back, the magnitude of the light that is returned does not affect the measurement. In other words, the type of object reflecting the light, or material from which the object is constructed has marginal, if any, impact on the time delay of the traveling light. As such, variation between objects that absorb light and objects that reflect light is significantly reduced, relative to reflected light/sound sensors and triangulation sensors. As a result, the time of flight sensor 40 can be utilized in highly reflective environments, such as a polished bathroom or kitchen sink, or situations where the sensor is aimed at a reflective surface such as a sink basin, toilet bowl or mirrored surface. Thus, time of flight sensors 40 give a significantly more reliable and error free distance measurement or presence of an object determination than reflected light/sound sensors or triangulation sensors. To further improve the sensing capabilities of the time of flight sensor 40, some example systems utilize an ambient light sensor in conjunction with the time of flight sensor. The ambient light sensor detects the level of ambient lighting, and allows the controller to compensate for any effects the level of ambient light will have on the expected time of flight.

In some example dispensing fixtures, the time of flight sensor 40 is a complete sensor module containing the emitter diode 110 the receiver 120 and a signal processing circuit 160. In these examples, the time of flight sensor module performs the signal processing calculations internally, and outputs a distance measurement, a binary presence determination, or any similar proximity determination to the valve controller 50. In alternate examples, the time of flight sensor 40 can include only the sensor elements (the emitter diode 110, and the receiver 120), and provide the time delay reading directly to the valve controller 50. In these examples, the valve controller 50 converts the time delay readings into a distance measurement, a binary presence determination, or any similar proximity determination and determines the appropriate response based on conversions internal to the valve controller 50.

In yet a further example, the time of flight sensor 40 can be a distinct sensor module, as described in the first example. In this example, the sensor module outputs the specific time delay measurements in addition to the determined distance measurement, binary presence determination, or similar proximity determination. The valve controller 50 can determine a distance measurement, a binary presence determination, or any similar proximity determination based on the time delay using internal valve controller 50 processing elements and logic. The two determined values are then compared with each other to verify the accuracy of the calculations, or for any other purpose.

In some example dispensing fixtures, the time of flight sensor 40 is maintained in a continuously on state and continuously detects for the presence of an object in a target area. In alternate examples, the time of flight sensor 40 interfaces with the valve controller 50 to determine when the time of flight sensor 40 will scan for objects. Initially, the valve controller 50 periodically wakes up the time of flight sensor 40 and instructs the time of flight sensor 40 to do a quick scan of the target area. If no object is detected, the time of flight sensor 40 is turned off, and the valve controller 50 waits a designated period before waking up the sensor 40 again.

In some alternate examples, when an object is detected in the target area, the valve controller 50 instructs the time of flight sensor 40 to remain on and continuously detect the distance between the time of flight sensor 40 and the object for a set period of time. This example generates oversampling of the time of flight data and allows the time of flight sensor 40 or the valve controller 50 to detect calculation errors and anomalous detections.

In yet further alternate examples, the time of flight sensor 40 can remain on continuously in a sampling scanning mode while the valve controller 50 is asleep, In this example the time of flight sensor 40 manages the determination of an object 150 being present or not and waking up the valve controller 50 when an object 150 is detected. Using the alternate arrangements, the energy use of the time of flight sensor 40 can be reduced relative to a continually scanning example. Furthermore, this example reduces the processing power required for the valve controller 50 to interpret the readings of the time of flight sensor 40, as the number of detections is reduced.

In yet a further alternate arrangement, the valve controller 50 can dynamically alter or adjust the frequency at which the detections are made. Dynamic adjustment allows the valve controller 50 to alter the frequency of the scans to compensate for an expected presence, a time of day, or any other factor. By way of example, an automated flush toilet in a public building can reduce the frequency at which the automatic flush mechanism scans during time periods when the building is closed, thereby reducing the overall power consumption of the sensor 40.

In yet a further alternate arrangement, the sensor arrangement can include an additional passive or low power proximity sensor configured to detect the presence of an object within a target zone of the time of flight sensor 40. In this embodiment, the time of flight sensor 40 can remain in an off state until the passive or low power proximity sensor detects an object, at which time the passive or low power proximity sensor can turn on the time of flight sensor 40. Such a configuration allows the time of flight sensor to remain off or idle until an object is actually present within the target zone.

In some examples, the time of flight sensor 40, 100 is integrated into the valve controller 50 housing, allowing the valve controller 50 and the time of flight sensor 40, 100 to be installed as a single package. This example arrangement reduces the overall footprint of the automatic dispensing fixture, and allows a time of flight sensor 40, 100 to be retroactively installed into an existing automatic dispensing fixture.

In yet a further example, a plumbing fixture, such as the shower fixture 20 of FIG. 1, can include multiple time of flight sensors 40. The multiple time of flight sensors 40 can be arranged linearly, or distributed throughout a plane to allow the detection of motion from one time of flight sensor's field of detection to another time of flight sensor's field of detection. By arranging the time of flight sensors 40 in this manner, the plumbing fixture can detect particular motions, or gestures, allowing for the implementation of gesture control for the plumbing fixture.

By way of example, a shower assembly 10 can be arranged such that the time of flight sensors detect movement in a circular motion. This motion can be tied to control operations of the shower fixture. In one example, a clockwise circular motion from a user can cause the shower assembly 10 to lower the temperature, while a counter clockwise circular motion can cause the shower assembly 10 to increase the temperature. Alternatively, clockwise and counterclockwise gestures can be utilized to control volumetric flowrate through the shower fixture. Additional, and more complex, gesture controls can be implemented with the inclusion of additional time of flight sensors. Furthermore, the gesture control is not limited to the illustrated shower assembly 10, and can be implemented in any number plumbing fixtures utilizing time of flight sensors.

While the above disclosure is drawn generally to a shower plumbing fixture, it should be understood that the principles illustrated can be applied to any plumbing fixture including a hand washing station, a dishwasher, kitchen plumbing fixtures, automatic flush toilets, or any other automated plumbing or dispensing fixture and still remain within the scope of the current disclosure. While described above as facilitating position detection of a user approaching an automatic dispenser, a similar arrangement utilizing the same principles can perform binary object present/not present detection and still fall within the disclosure.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. An automated dispensing fixture comprising:
a controller controllably coupled to at least one valve operable to control fluid flow through a dispensing fixture; and
at least one time of flight sensor communicatively coupled to the controller, such that said controller is operable to detect a position of an object relative to the dispensing fixture.

2. The automated dispensing fixture of claim 1, wherein the at least one time of flight sensor includes a plurality of time of flight sensors arranged in one of a linear arrangement and a planar arrangement such that said plurality of time of flight sensors are operable to detect at least one gesture.

3. The automated dispensing fixture of claim 2, wherein the controller includes gesture interpretation logic configured to receive a detected gesture from said plurality of time of flight sensors and convert the detected gesture into a corresponding valve control response.

4. The automated dispensing fixture of claim 1, wherein said at least one time of flight sensor comprises an emitter configured to emit a light pulse, a receiver configured to receive a reflected light pulse and a signal processing circuit operable to detect a time delay between emission of the light from said emitter and receipt of the reflected light pulse at said receiver.

5. The automated dispensing fixture of claim 4, wherein at least one of said controller and said at least one time of flight sensor includes a processor configured to convert said time delay to a distance of an object reflecting said emitted light.

6. The automated dispensing fixture of claim 4, wherein said emitter is an infrared emitting diode.

7. The automated dispensing fixture of claim 1, wherein said at least one time of flight sensor is configured to communicate at least one of a time delay output and an object distance output to said controller.

8. The automated dispensing fixture of claim 7, wherein said at least one time of flight sensor is configured to communicate said time delay output and said object distance output to said controller.

9. The automated dispensing fixture of claim 1, wherein said controller and said at least one time of flight sensor are installed in an automated dispensing fixture as a single package, the single package including a housing containing at least part of the time of flight sensor and the controller.

10. The automated dispensing fixture of claim 1, wherein the dispensing fixture is one of an automated flush toilet, an automated flush urinal, an automated faucet, a handwashing station, a dishwasher, a kitchen plumbing fixture, an automated soap dispenser, an automated drinking fountain, and an automated shower.

11. A method of operating an automated dispensing fixture comprising:
detecting a position of an object relative to the dispensing fixture utilizing at least one time of flight sensor by
emitting a pulse of light from an emitter in the at least one time of flight sensor;
detecting a reflection of the emitted pulse of light at a receiver in the at least one time of flight sensor;
detecting a travel time of the emitted pulse of light based on said detected reflected pulse of light;
determining a first value representative of at least one of a distance between the object and the dispensing fixture and the presence of the object in a target area based on the time delay of the pulse of reflected light; and
transmitting the value to a controller operable to control the automatic dispensing fixture.

12. The method of claim 11, further comprising:
transmitting a value representative of the travel time to said controller, and determining a second value representative of at least one of a distance between the object and the dispensing fixture and the presence of the object in a target area based on the time delay of the reflected light using the controller; and
verifying an accuracy of the first value by comparing the first value to the second value using said controller.

13. The method of claim 11, wherein said at least one time of flight sensor is a plurality of time of flight sensors and the method further comprises:
determining at least one gesture based on the determined first value of each of said time of flight sensors in said plurality of time of flight sensors; and
initiating a control action using said controller based on said determined gesture.

14. The method of claim 11, wherein emitting said pulse of light from said emitter in the at least one time of flight sensor comprises emitting a pulse of infrared light from one of an infrared emitter diode and a vertical-cavity surface-emitting laser.

15. The method of claim 11, wherein the automated dispensing fixture is positioned in a reflective environment.

16. The method of claim 11, further comprising operating the at least one time of flight sensor and the controller in a reduced power consumption mode.

17. The method of claim 16, wherein the reduced power consumption mode comprises placing the at least one time of flight sensor in a power saving mode, such that said time of flight sensor scans a target area for an object at a set period.

18. The method of claim 16, further comprising placing the controller in a sleep mode, continuously scanning a target area for an object, and signaling said controller to exit said sleep mode when an object is detected.

19. The method of claim 16, further comprising detecting a presence of an object in a target zone using one of a passive proximity sensor and a low power proximity sensor and activating the time of flight sensor in response to detecting the presence of the object.

20. An automated dispensing fixture comprising:
a controller controllably coupled to at least one actuator operable to control flow through a dispensing fixture;
at least one time of flight sensor communicatively coupled to the controller, such that said controller is operable to detect a position of an object relative to the dispensing fixture; and
wherein the actuator is one of a motor and a solenoid.
